(19) United States
(12) Patent Application Publication
(10) Pub. No.: US 2026/0229966 A1
(43) Pub. Date: Aug. 6, 2026

(54) ELECTRIC MACHINE, IN PARTICULAR FOR A MOTOR VEHICLE, METHOD FOR PRODUCING SUCH AN ELECTRIC MACHINE AND METHOD FOR OPERATING SUCH AN ELECTRIC MACHINE

(71) Applicant: MERCEDES-BENZ GROUP AG, Stuttgart (DE)

(72) Inventors: Michael SAUR, Tübingen (DE); Maximilian HEPP, Stuttgart (DE); Jörg WEIGOLD, Stuttgart (DE); Alexander NISCH, Rottenburg (DE)

(21) Appl. No.: 19/151,035

(22) PCT Filed: Jan. 25, 2024
(86) PCT No.: PCT/EP2024/051817

§ 371 Date: Jul. 25, 2025

(30) Foreign Application Priority Data
Jan. 27, 2023 (DE) 10 2023 000 252.6

(51) Int. Cl. H02K 11/215; H02K 1/16; H02K 15/40

(52) U.S. Cl. CPC H02K 11/215; H02K 1/16; H02K 15/40; H02K 2211/03

(57) ABSTRACT

An electric machine includes at least one winding that can create a magnetic field and a sensor device to detect the magnetic field. The sensor device has at least one circuit board with several circuit board regions, at least partially spaced apart from each other in the circumferential direction of the electric machine. Respective longitudinal regions of the winding are arranged between the several circuit board regions. Magnetic field sensors are held on the circuit board and detect the magnetic field.

### BACKGROUND AND SUMMARY OF THE INVENTION

Exemplary embodiments of the invention relate to an electric machine, in particular for a motor vehicle, a method for producing such an electric machine, and a method for operating such an electric machine.

A rotor position encoder for an electric machine is taken as known from DE 10 2016 005 232 A1, having a capacitive sensor in which a first capacitor element is arranged on a rotating element and a second capacitor element and a third capacitor element are arranged on a static element of the electric machine. Furthermore, DE 10 2013 020 985 A1 discloses an electric machine, in particular for a motor vehicle, having a housing, a rotor shaft, arranged at least partially in the housing, which can be rotated around a rotational axis relative to the housing, and having a sensor device, comprising at least one rotor part connected to the rotor shaft for conjoint rotation and at least one stator part corresponding thereto and fixed at least indirectly on the housing, for detecting at least one measured variable characterizing rotation of the rotor shaft relative to the housing. DE 10 2013 225 141 A1 discloses a position sensor device for detecting the angular position of the rotor of an electric machine. A sensor device for detecting the rotational position of a rotating component is known from DE 10 2008 042 912 A1. DE 10 2007 060 241 A1 discloses an electric machine having a stator and a rotor and a sensor device for detecting the relative position between the stator and the rotor. An electric machine is taken as known from DE 10 2012 009 906 A1, having a stator, a rotor moving relative to the stator and having at least one sensor device. Furthermore, DE 10 2005 004 322 A1 discloses an electric machine. A sensor arrangement is taken as known from DE 103 31 505 A1, having an angle sensor for determining the position angle of a permanently excited synchronous machine. Furthermore, a sensor arrangement is known from DE 10 2007 028 482 A1, comprising at least one sensor element which is arranged on at least one circuit board.

An electronically commutated motor assembly having a motor housing opening into which a sensor housing having at least one Hall effect sensor can be brought into engagement is known from EP 2 214 296 A1. The Hall effect sensor sits on extensions of a circuit board which protrude out from openings of the sensor housing and are positioned in slots between the teeth of the stator laminations of the motor in the axial direction.

DE 10 2021 201 605 A1 relates to a rotor for an electric machine, wherein the rotor has at least one sensor element, in order to detect a state variable of the rotor. A signal processing unit generates measured data from the detected state variable of the rotor, which data are transmitted to a control device. An induction coil arranged on an end face of the rotor is used to generate electrical energy during the operation of the electric machine from a front stray field of the stator and this energy is provided to the sensor element and the signal processing unit.

Exemplary embodiments of the present invention are directed to an electric machine, in particular for a motor vehicle, a method for producing such an electric machine, and a method for operating such an electric machine, so that a magnetic field of the electric machine can be detected in a particularly advantageous manner.

A first aspect of the invention relates to an electric machine, in particular for a motor vehicle. This means, for example, that in its completely produced state, the motor vehicle, also referred to as a vehicle and designed, for example, as a motor car, in particular a passenger car, has the electric machine and can be driven electrically, in particular purely electrically, by means of the electric machine. The electric machine has at least one winding, by means of which a magnetic field can be created, in particular for driving a rotor of the electric machine. This means, for example, that in its completely produced state, the electric machine has the mentioned rotor that can be driven by means of the magnetic field. For example, the electric machine in its completely produced state also has a stator, wherein the rotor can be rotated around a machine rotational axis of the electric machine relative to the stator. In particular, the rotor can be driven by means of the stator and thus can be rotated around the machine rotational axis relative to the stator. In particular, it is conceivable that the mentioned winding is a winding of the stator and therefore is also referred to as a stator winding. For example, the electric machine can provide drive torques via its rotor for driving the motor vehicle. The electric machine also has a sensor device, by means of which the magnetic field can be detected. In particular, a measured variable such as a magnetic flux of the magnetic field, characterizing, i.e., describing or specifying, the magnetic field, can be detected by means of the sensor device. In other words, for example, the sensor device can detect a magnetic flux of the magnetic field and thus the magnetic field, wherein the magnetic flux is also referred to as a magnet flux. As the magnetic field can be used, for example, in order to drive the rotor, the magnetic field is also referred to, for example, as a rotor magnetic field. In particular, the magnetic field can be measured by means of the sensor device, so that detecting or measuring the magnetic field is also referred to as magnetic field measuring or rotor magnetic field measuring.

In order to be able to detect the magnetic field particularly advantageously, it is provided according to the invention that the sensor device has a circuit board, which is also referred to as a conductor board or as a PCB, and has several circuit boards regions at least partially, in particular completely, spaced apart from each other in the circumferential direction of the electric machine, between which circuit board regions respective longitudinal regions of the winding are arranged. The circumferential direction of the electric machine runs around the machine rotational axis. As the circuit board regions are at least partially spaced apart from each other, respective through-openings are arranged between the circuit board regions in the circumferential direction of the electric machine, which are continuous, in particular in the axial direction of the electrical machine, coinciding with the machine rotational axis in the axial direction. In this case, the through-openings are penetrated by the longitudinal regions of the winding, in particular in the axial direction of the electric machine. In particular, the circuit board regions are arranged between the longitudinal regions of the winding in the circumferential direction of the electric machine in such a way that the longitudinal regions and the circuit board regions are arranged alternately following each other when viewed in the circumferential direction of the electric machine. Furthermore, it is provided according to the invention that the sensor device has magnetic field sensors held on the circuit board, by means of which the magnetic field or the measured variable can be detected. In particular, a number of the magnetic field sensors is at least 10. Preferably, the number of the magnetic field sensors is greater than 10, in particular greater than or equal to 100. The invention enables a particularly cost-effective construction of the electric machine, as the machine can be produced with only low material costs. Furthermore, cost-effective mounting is required, as, for example, a rotating part, provided specially for detecting, furthermore for measuring the magnetic field is not required and thus does not have to be mounted. Furthermore, a particularly space-efficient and weight-optimized design of the electric machine can be realized, as the magnetic field can be detected with only a low number of parts.

In particular, it is conceivable that the sensor device has several circuit boards, specifically the aforementioned circuit board and at least one or more further circuit boards, wherein the above and following embodiments for the first circuit board can be easily transferred to the respective further circuit boards and vice versa. This means that it is possible, for example, the magnetic field to detect the magnetic field simply and redundantly by means of the circuit boards and the respective magnetic field sensors held thereon. For example, failure of a current sensor system can be detected in good time by detecting or measuring the magnetic field sensor or the magnetic flux. Subsequently, emergency operation of the electric machine can be realized, which can be operated, in particular controlled or regulated, in the emergency mode in accordance with the detected magnetic field.

In order to be able to realize a particularly weight-optimized, space-efficient and cost-effective construction of the electric machine, and thus to be able to detect the magnetic field in a weight-optimized, cost-effective, and space-efficient manner, it is provided according to the invention that the circuit board regions are designed as teeth, which are also referred to as tabs or prongs. The teeth protrude inwards in the radial direction of the electric machine-the radial direction of which runs perpendicular to the axial direction of the electric machine-from a base region of the circuit board, common to the teeth. The teeth are held on the base region and are held against each other via the base region, in particular in such a way that the teeth and the base region are designed together as one piece, i.e., are formed from a single piece. In particular, this is understood to mean that the teeth and the base region are not assembled from parts that have been designed separately from each other and connected together, but preferably the teeth and the base region are formed from a single piece, i.e., are designed as a monoblock or formed by a monoblock. Expressed again in other words, it is preferably provided that the teeth and the base region are formed from an integral body that has been produced in one piece, i.e., formed from a single piece and thus produced integrally. The respective tooth ends in the radial direction of the electric machine inwards in a respective free end of the respective tooth, opposite to the ring region. Thus, the circuit board is comb-shaped, i.e., designed in the shape of a comb, whose prongs are the teeth. Therefore, a cost-effective, space-efficient and weight-optimized construction of the circuit board and thus of the sensor device overall can be achieved, wherein furthermore time-efficient and cost-effective mounting of the circuit board can be achieved.

According to the invention, the circuit board is characterized in that the base region is designed to be circular or circular-segment-shaped on its side that faces away from the teeth and pointing outwards in the radial direction of the electric machine. Therefore, an outer-circumferential, particularly space-efficient construction of the circuit board and thus of the sensor device overall can be achieved, so that the circuit board and thus the sensor device can be installed particularly advantageously. Thus, the magnetic field can be detected particularly well.

According to the invention, it is provided that the circuit board is inserted from the outside inwards between the longitudinal regions in the radial direction of the electric machine. Therefore, the circuit board and thus the sensor device can be mounted particularly time-efficiently and cost-effectively, whereby the electric machine can be produced particularly time-efficiently and cost-effectively. Thus, the magnetic field can be detected, i.e., measured, in a particularly cost-effective manner.

In order to be able to detect the magnetic field particularly precisely and thus advantageously, it is provided in one embodiment of the invention that a respective one, in particular exactly one, of the magnetic field sensors is held on the respective circuit board region.

In a further embodiment of the invention, it is provided that the magnetic field sensors are each at least partially embedded into the circuit board. Therefore, a particularly space-efficient construction of the sensor device can be achieved, meaning that the magnetic field can be detected particularly well.

In a further embodiment of the invention, it is provided that the circuit board is produced by an injection molding process. In other words, the circuit board is preferably produced by injection molding. This means that even a complex geometry of the circuit board may be produced as needed in a particularly cost-effective manner, so that the circuit board can be arranged advantageously, in particular in relation to the winding. Therefore, the magnetic field can be detected particularly advantageously.

In order to be able to produce the circuit board particularly cost-effectively, it is provided in a further embodiment of the invention that the circuit board is produced by laser direct structuring (LDS).

In a further, particularly advantageous embodiment of the invention, it is provided that the electric machine has a laminated core bearing the winding, which is designed, in particular, separately from the winding.

In this case, it has proven particularly advantageous when a respective laminated segment of the laminated core adjoins the circuit board on both sides in the circumferential direction of the electric machine. Therefore, the circuit board is integrated into the laminated core, in particular in the axial direction of the electric machine, particularly space-efficiently, so that a particularly space-efficient construction can be realized, in particular when viewed in the axial direction of the electric machine.

For example, the circuit board is designed to be a good fit for a yoke of the stator, also referred to as a stator yoke, and/or for an electric pole of the electric machine, so that particularly advantageous integration of the circuit board and thus of the sensor device into the electric machine can be achieved. For example, the circuit board is arranged directly between the stator yoke and a winding head of the winding, in particular in the axial direction of the electric machine, whereby a particularly advantageous arrangement of the circuit board and thus of the sensor device can be achieved. Thus, the magnetic field can be detected, i.e., measured, particularly well.

For example, the stator yoke is the laminated core. The mentioned winding head is formed, for example, by the mentioned longitudinal regions of the winding in that the longitudinal regions and therefore the winding head protrude from the stator or from the laminated core in the axial direction of the electric machine. In particular, it is provided that the longitudinal regions of the winding and thus the winding head protrude from an axial end face of the stator yoke or of the laminated core in the axial direction of the electric machine.

A further embodiment is characterized in that the respective laminated segment and the circuit board are arranged at least partially at the same height, as viewed in the axial direction of the electric machine. Therefore, a particularly space-efficient construction when viewed in the axial direction of the electric machine can be achieved, and the circuit board and thus the sensor device can be integrated into the electric machine particularly advantageously, so that the magnetic field can be detected particularly well.

Furthermore, it is provided that the respective laminated segment and the circuit board are arranged flush to each other, in particular on a respective, axial end face which, for example, faces towards the winding head, whereby a particularly space-Attorney efficient construction can be achieved. Thus, the magnetic field can be detected particularly advantageously.

For example, the circuit board is overlapped at least partially, in particular at least predominantly and thus at least more than half or completely, by the laminated core in a first direction running parallel to the axial direction of the electric machine or coinciding with the axial direction of the electric machine. In this case, for example, it is provided that the circuit board is arranged completely without overlap with respect to the laminated core in a second direction, running parallel to the axial direction of the electric machine or coinciding with the axial direction of the electric machine, opposing the first direction, i.e., is not overlapped by the laminated core. Therefore, the magnetic field can be detected particularly advantageously by means of the sensor device, and the sensor device can be installed particularly simply and thus time-efficiently and cost-effectively.

In a further embodiment of the invention, the respective magnetic field sensor is designed as a Hall sensor, whereby the magnetic field can be detected cost-effectively.

In order to be able to detect the magnetic field particularly precisely and thus particularly advantageously, it is provided in a further embodiment of the invention that the respective magnet sensor is designed as an anisotropic magnetoresistive sensor, i.e., an AMR sensor.

Finally, it has proven particularly advantageous when the sensor device is designed to determine, that is to say ascertain, at least one rotational position, also referred to as an angular position, of the rotor of the electric machine and/or an amplitude of the magnetic field and/or a temperature of the electric machine, depending on the detected magnetic field or depending on the detected measured variable. As the rotor can be rotated around the machine rotational axis relative to the stator, the rotor can be rotated into several different rotational positions or angular positions, relative to the stator. In this case, for example, at least or exactly one of the rotational positions or several of the rotational positions or angular positions can be detected by means of the sensor device depending on the magnetic field. In particular, for example, it is provided that the higher accuracy, also referred to as angular accuracy, with which the at least one rotational position or the rotational positions can be determined, the higher the number of the magnetic field sensors. The background of the invention is in particular that the electric machine, preferably designed as a rotary field machine, can be operated, in particular controlled, particularly advantageously depending on the rotational position also referred to as a rotor position.

Typically, determination of the rotor position is very inaccurate with the aid of magnetic field sensors or it requires a particularly high number of sensors, which have to be mounted individually with exact positioning, which leads to a very cost-intensive production process. The invention now enables the circuit board and thus the sensor device to be mounted time-efficiently and cost-effectively and particularly precisely, so that the magnetic field and, for example, subsequently the at least one rotational position can be detected precisely and in a cost-effective manner. The amplitude, also referred to as flux amplitude or rotor flux amplitude, can be used as very advantageous extra information, in order to be able to determine, in particular to ascertain and more particularly to calculate the temperature depending on the amplitude, in particular from the amplitude, wherein the temperature is, for example, a temperature of the rotor, also referred to as a rotor temperature. Furthermore, for example, particularly advantageous state monitoring of the electric machine can be realized depending on the amplitude. The invention furthermore enables demagnetization or partial demagnetization of the rotor and bearing damage and further damage to be detected in good time, so that particularly advantageous operation of the electric machine can be achieved.

A second aspect of the invention relates to a method for producing an electric machine, in particular according to the first aspect of the invention. In the method according to the second aspect of the invention, the electric machine is equipped with at least one winding, by means of which a magnetic field can be generated, and with at least one sensor device, by means of which the magnetic field can be detected.

In order to be able to detect the magnetic field particularly advantageously, it is provided in the second aspect of the invention that the sensor device is produced from a circuit board having several circuit board regions that are at least partially, in particular completely, spaced apart from each other in the circumferential direction of the electric machine and between which respective longitudinal regions of the winding are arranged. Furthermore, the sensor device is produced from magnetic field sensors held on the circuit board, by means of which sensors the magnetic field can be detected. Advantages and advantageous embodiments of the first aspect of the invention are to be regarded as advantages and advantageous embodiments of the second aspect of the invention and vice versa.

A third aspect of the invention relates to a method for operating an electric machine according to the first aspect of the invention. Advantages and advantageous embodiments of the first aspect and of the second aspect of the invention are to be regarded as advantages and advantageous embodiments of the third aspect of the invention and vice versa.

Further advantages, features and details of the invention can be seen from the following description of a preferred exemplary embodiment and with reference to the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The figures show:

FIG. 1 a schematic perspective view of a stator of an electric machine, in particular for a motor vehicle; and

FIG. 2 a schematic perspective view of a section of a circuit board of a sensor device of the electric machine.

In the figures, identical or functionally identical elements are provided with the same reference signs.

### DETAILED DESCRIPTION

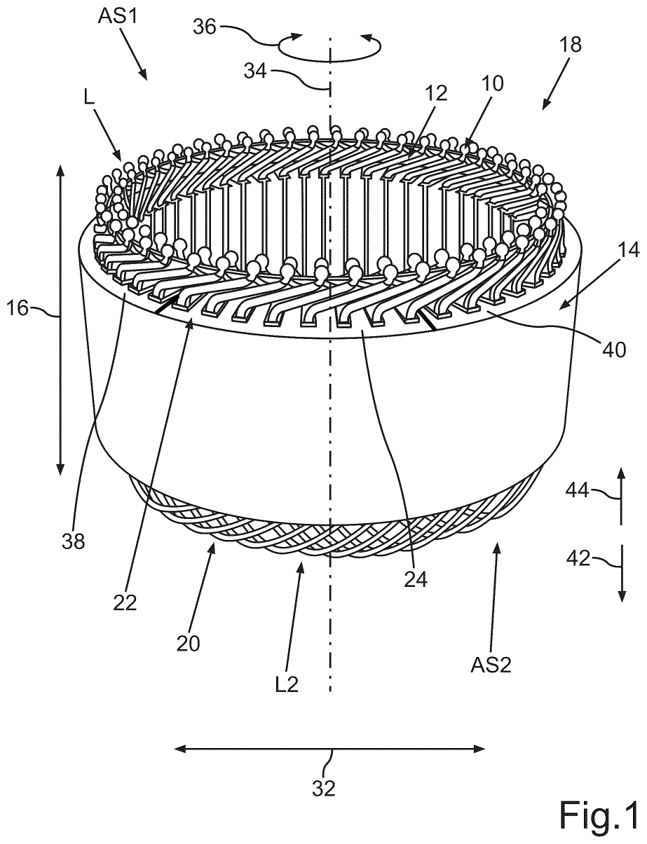

FIG. 1 shows, in a schematic perspective view, a stator 10 of an electric machine, in particular of a motor vehicle. This means that the motor vehicle, also simply referred to as a vehicle and designed, for example, as a motor car, in particular as a passenger car, has the electric machine and can be driven electrically, in particular purely electrically, by means of the electric machine. Preferably, the electric machine is a high-voltage component, the electric voltage of which, in particular electric operating or rated voltage, is preferably greater than 50 volts, in particular greater than 60 volts, and more preferably is several hundred volts. In its fully produced state, the electric machine has the stator 10 and a rotor, not shown in the figures, which can be rotated around a machine rotational axis of the electric machine, the axial direction of which coincides with the machine rotational axis, relative to the stator 10. In particular, the electric machine can provide drive torques via its rotor for driving the motor vehicle.

The electric machine, in particular the stator 10, has at least one winding 12, by means of which a magnetic field, in particular having a magnetic flux, also simply referred to as a flux or magnet flux, can be created. More preferably, the winding 12 is designed according to hairpin technology, and is therefore also referred to as a hairpin winding. As the winding 12 is a winding of the stator 10, the winding 12 is also referred to as a stator winding. The stator 10 and thus the electric machine have a laminated core 14 on which the winding 12 is held. Thus, the winding 12 is supported by the laminated core 14. The axial direction of the electric machine and thus of the stator 10 is illustrated in FIG. 1 by a double arrow 16. For example, the laminated core 14 is formed, in particular composed, of several laminated segments designed separately from each other and connected to each other. It can be seen from FIG. 1 that respective longitudinal regions L of the winding 12 protrude on a first axial end face AS1 of the laminated core 14 in the axial direction of the laminated core 14 from the laminated core 14, in particular from the axial end face AS1, whereby the longitudinal regions L form at least one winding head 18 of the winding 12 that is/are arranged on the axial end face AS1. The laminated core 14 also has, for example, a second axial end face AS2, facing away from the axial end face AS1 in the axial direction of the electric machine. In this case, it is conceivable, for example, that second longitudinal regions L2 of the winding 12 protrude from the laminated core 14, in particular from the axial end face AS2, on the axial end face AS2 in the axial direction of the electric machine and thus of the stator 10, whereby, for example, the longitudinal regions L2 form a second winding head 20 of the winding 12 on the second axial end face AS2.

The electric machine furthermore has a sensor device 22, by means of which the magnetic field, in particular the magnetic flux, can be detected.

In order to now be able to particularly advantageously detect, i.e., measure, the magnetic field, the sensor device 22 has at least one circuit board 24, which is preferably designed separately from the laminated core 14 and, for example, is at least indirectly, in particular directly, connected to the laminated core 14.

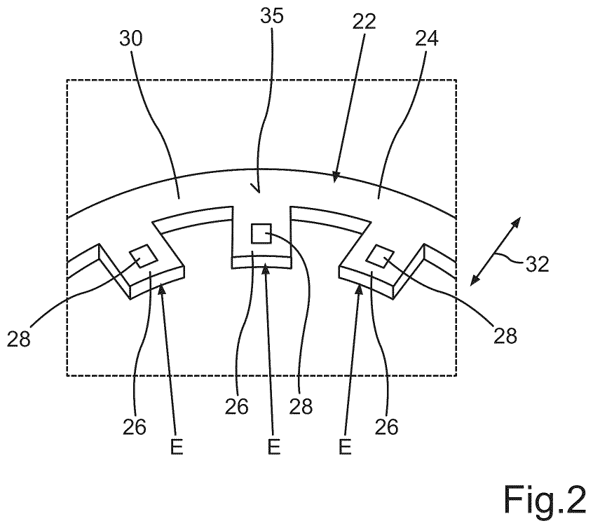

FIG. 2 shows, in a schematic perspective view, a section of the sensor device 22. The circuit board 24 can be seen particularly well from FIG. 2, which circuit board has circuit board regions 26 that are at least partially, in the present case completely, spaced apart from each other in the circumferential direction of the electric machine running in around the machine rotational axis, between which circuit board regions 26 the longitudinal regions L are arranged. Expressed conversely, the circuit board regions 26 are arranged between the longitudinal regions L in the circumferential direction of the electric machine.

The sensor device 22 also has magnetic field sensors 28, which are held on the circuit board 24 and therefore are supported by the circuit board 24 in particular in such a way that the magnetic field sensors 28 are each embedded at least partially into the circuit board 24. Thus, the circuit board 24 is equipped with the magnetic field sensors 28. The magnetic field can be detected by means of the magnetic field sensors 28. Thus, for example, it is provided in the method for operating the electric machine that the magnetic field is detected by means of the magnetic field sensors 28. For example, the magnetic field sensors 28 and thus the sensor device 22 provide at least one, in particular electrical, signal, which characterizes the magnetic field that is detected, i.e., measured, by means of the magnetic field sensors 28.

It can be seen from FIG. 2 that a respective one, in particular exactly one, of the magnetic field sensors 28 is held on the respective circuit board region 26. Thus, for example, the magnetic field sensors 28 are arranged between the longitudinal regions L.

In the exemplary embodiment shown in the figures, the circuit board regions 26 are designed as teeth or prongs protruding inwards in the radial direction of the electric machine and thus of the stator 10 from a base region 30 of the circuit board 24, common to the teeth, and end inwards in the radial direction of the electric machine and thus of the stator 10 at a respective free end E of the respective tooth, opposite to the base region 30. Thus, the circuit board 24 is comb-shaped, in the present case in such a way that the circuit board 24 is designed in the shape of a comb, curved around the machine rotational axis. This means that it is possible to mount the circuit board 24 in such a particularly time-efficient and cost-effective manner that, in the method for producing the electric machine, the circuit board 24 is inserted from the outside inwards between longitudinal regions L in the radial direction of the electric machine and thus of the stator 10. The radial direction of the electric machine and thus of the stator runs perpendicular to the axial direction of the electric machine and thus of the stator and is illustrated by a double arrow 32 in FIGS. 1 and 2. The axial direction of the electric machine and thus of the stator 10 is illustrated by a dash-dotted line 34 in FIG. 1, wherein the circumferential direction of the electric machine and thus of the stator 10 runs around the axial direction and is illustrated by a double arrow 36.

It can be seen from FIG. 2 that the base region 30 is circular-segment-shaped on its side 35 facing away from the teeth (circuit board regions 26) and pointing outwards in the radial direction of the electric machine. It can be seen from FIG. 1 that a respective one of the laminated segments from which the laminated core 14 is formed adjoins the circuit board 24 on both sides in the circumferential direction of the electric machine and thus of the stator 10, wherein a first one of the laminated segments adjoining the circuit board 24 in the circumferential direction is labelled with 38 and a second one of the laminated segments adjoining, in particular directly, the circuit board 24 in the circumferential direction is labelled with 40. The respective laminated segment 38, 40 and the circuit board 24 are arranged at least partially, in particular completely, at the same height, as viewed in the axial direction of the electric machine, in the present case in such a way that the respective laminated segment 38, 40 and the circuit board 24 are arranged flush to each other on the axial end face AS1. In this case, the circuit board 24 is covered, at least partially, in particular at least predominantly or completely, by the laminated core 14 in a first direction illustrated by an arrow 42, wherein the first direction, illustrated by the arrow 42, runs parallel to the axial direction or coincides with the axial direction. The circuit board 24 is arranged completely without overlap with respect to the laminated core 14 in a second direction that is counter to the first direction and illustrated by an arrow 44, and thus is not overlapped by the laminated core 14, wherein the second direction runs parallel to the axial direction or coincides with the axial direction and is opposed to the first direction. Thus, the circuit board 24 is arranged in the axial direction of the electric machine between the winding head 18 and at least one longitudinal region of the laminated core 14, whereby the magnetic field can be detected particularly advantageously. In particular, the magnetic field sensors 28 are arranged between the winding head 18 and at least the longitudinal region of the laminated core 14 in the axial direction.

In order to be able to detect the magnetic field particularly precisely, it is preferably provided that the respective magnetic field sensor is designed as an AMR sensor, i.e., as an anisotropic magnetoresistive sensor.

It has proven particularly advantageous when the sensor device 22 is designed to determine, that is to say to ascertain, at least one rotational position, in particular several rotational positions, of a rotor, in particular in relation to the stator 10 and/or an amplitude of the magnetic field and/or a temperature of the electric machine, depending on the detected magnetic field. The respective rotational position is also referred to as a rotor position and can be used, for example, to operate, in particular regulate, the electric machine depending on the determined rotational position. The higher the number of magnetic field sensors 28, the higher the accuracy with which the rotational position of the rotor can be determined. Therefore, a particularly precise regulation of the electric machine can be ensured.

Preferably, it is provided that at least one of the laminated segments of the laminated core 14 and the circuit board 24 itself, that is to say considered alone, are designed to be structurally identical, i.e., identical, in particular at least with regard to their respective outer contours, i.e., outer circumferential shapes. Preferably, the number of the magnetic field sensors 28 is in a range from 10 to 100 inclusive. More preferably, the circuit board 24 is produced by an injection molding process and by a laser direct structuring method, i.e. by laser direct structuring (LDS). The fact that the circuit board 24 is preferably designed in the form of a laminated segment of the laminated core 14 means that the circuit board 24 can be introduced into the finished winding 12, designed for example as a hairpin winding, in a time-saving and cost-effective manner, in particular in such a way that the presently comb-shaped circuit board 24 is inserted from the outside inwards between the longitudinal regions L of the winding 12 in the radial direction.

The temperature, which is for example a rotor temperature, can, for example, be calculated depending on the amplitude, in particular from the amplitude, for example in that the amplitude changes proportionally to the temperature. For example, bearing damage can be recognized by detecting the magnetic field or the magnetic flux, and a position signal can be detected redundantly, for example. Furthermore, for example, a change to the electric machine due to ageing, temperature or other damage can be compensated for. Moving parts or couplings are no longer required in comparison to conventional solutions and thus can be avoided, meaning that a particularly high level of robustness can be achieved.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

10 stator
12 winding
14 laminated core
16 double arrow
18 winding head
20 winding head
22 sensor device
24 circuit board
26 circuit board region
28 magnetic field sensor
30 base region
32 double arrow
34 dash-dotted line
35 side
36 double arrow
38 laminated segment
40 laminated segment
42 arrow
44 arrow
AS1 axial end face
AS2 axial end face
L longitudinal regions
L2 longitudinal regions
E free end

1-12. (canceled)

13. An electric machine comprising:
at least one winding configured to create a magnetic field;
a laminated core bearing the at least one winding;
a sensor device configured to detect the magnetic field, wherein the sensor device comprises
a circuit board having several circuit board regions, wherein the several circuit board regions are at least partially spaced apart from each other in a circumferential direction of the electric machine, and wherein respective longitudinal regions of the winding are arranged between the several circuit board regions; and
magnetic field sensors fixed on the circuit board and configured to detect the magnetic field,
wherein the circuit board is arranged on an axial end face of the laminated core,
wherein the several circuit board regions are teeth protruding inwards in a radial direction of the electric machine from a base region of the circuit board, common to the teeth, and end inwards in the radial direction of the electric machine at a respective free end of the respective tooth, opposite to the base region,
wherein the base region is circular or circular-segment-shaped on a side facing away from the teeth and pointing outwards in the radial direction of the electric machine, and
wherein the circuit board is inserted from an outside inwards between the longitudinal regions in the radial direction of the electric machine.

14. The electric machine of claim 13, wherein a respective one of the magnetic field sensors is fixed on the respective circuit board region.

15. The electric machine of claim 13, wherein the magnetic field sensors are each at least partially embedded into the circuit board.

16. The electric machine of claim 13, wherein the circuit board is produced by an injection moulding process.

17. The electric machine of claim 13, wherein the circuit board is produced by laser direct structuring.

18. The electric machine of claim 13, wherein a respective laminated segment of the laminated core adjoins the circuit board on both sides in the circumferential direction of the electric machine.

19. The electric machine of claim 18, wherein the respective laminated segment and the circuit board are arranged at least partially at a same height, as viewed in the axial direction of the electric machine.

20. The electric machine of claim 13, wherein the magnetic field sensors are Hall sensors or anisotropic magnetoresistive sensors.

21. The electric machine of claim 13, wherein the sensor device is configured to determine, based on the detected magnetic field, at least one rotational position of a rotor of the electric machine, an amplitude of the magnetic field, or a temperature of the electric machine.

22. A method for producing an electric machine, in which the electric machine comprises at least one winding configured to create a magnetic field can be created, and at least one sensor device configured to detect the magnetic field, the method comprising:
producing a laminated core and affixing the at least one winding to the laminated core;
producing the sensor device from
a circuit board having several circuit board regions, wherein the several circuit board regions are at least partially spaced apart from each other in a circumferential direction of the electric machine, and wherein respective longitudinal regions of the winding are arranged between the several circuit board regions; and
magnetic field sensors fixed on the circuit board and configured to detect the magnetic field; and
arranging the circuit board on an axial end face of the laminated core,
wherein the several circuit board regions are teeth protruding inwards in a radial direction of the electric machine from a base region of the circuit board, common to the teeth, and end inwards in the radial direction of the electric machine at a respective free end of the respective tooth, opposite to the base region,
wherein the base region is circular or circular-segment-shaped on a side facing away from the teeth and pointing outwards in the radial direction of the electric machine, and
wherein the circuit board is inserted from an outside inwards between the longitudinal regions in the radial direction of the electric machine.
